(19) United States
(12) Patent Application Publication
(10) Pub. No.: US 2025/0392088 A1
(43) Pub. Date: Dec. 25, 2025

(54) Floating Electrical Connector

(71) Applicant: ZEBRA TECHNOLOGIES CORPORATION, Lincolnshire, IL (US)

(72) Inventors: Li-Ko Wang, New Taipei City (TW); Ge Lin, Mississauga (CA); Zhiming Zhang, Richmond Hill (CA); Yanmin Mao, Brampton (CA)

(21) Appl. No.: 18/790,450

(22) Filed: Jul. 31, 2024

Related U.S. Application Data
(60) Provisional application No. 63/662,583, filed on Jun. 21, 2024.

(51) Int. Cl. H01R 24/66; H01R 13/424; H01R 13/52; H01R 43/26

(52) U.S. Cl. CPC H01R 24/66; H01R 13/424; H01R 13/5219; H01R 43/26; H01R 2201/06

(57) ABSTRACT

An electronic device has a housing with a device interface area. The device interface area includes an electrical connector operatively coupled to the housing, where the first electrical connector includes a first casing that supports blade-style electrical contacts and includes a resilient member that forms a sleeve around the first casing such that the first casing nests within the resilient member. The resilient member is disposed between the casing and the housing. The casing is configured to be movable relative to the housing by reversibly deforming the resilient member.

### RELATED APPLICATIONS

The present application claims priority to and the benefit of U.S. Provisional Application No. 63/662,583, filed on Jun. 21, 2024, which is incorporated by reference herein in its entirety.

### BACKGROUND

For electronic devices that are powered by battery packs, the electrical and mechanical connections of the battery packs and the electronic devices generally must be durable to ensure uninterrupted operation of the electronic device and to prevent damage to the electrical connectors at which the battery packs and the electronic devices interface. A typical battery connector for such applications are pogo pin-style connector and blade-style connectors. Several issues can arise with pogo pin connectors, such as chattering, plating wear, and corrosion. Thus, for some applications, a blade-style connector may be utilized over a pogo pin-style connector. Typically, blade-style connectors have superior wear resistance and more robust connection capabilities as compared to pogo pin-style connectors. However, blade-style connectors are typically more susceptible to damage, particularly in cases of bending of the connector blade or housing cracking.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an example system including devices electrically coupled via a pair of electrical connectors including at least one floating connector in accordance with embodiments of the present disclosure.

FIG. 2 is a schematic view that illustrates an embodiment of the system shown in FIG. 1 in accordance with embodiments of the present disclosure.

FIG. 3 is a cross sectional view of an embodiment of the system shown in FIG. 1 illustrating an interconnection of a first device and a second device in accordance with embodiments of the present disclosure.

FIG. 4 illustrates an example interface of first device including a first electrical connector in accordance with embodiments of the present disclosure.

FIG. 5 illustrates an example interface of second device including a second electrical connector in accordance with embodiments of the present disclosure.

FIG. 6 is a plan view of a pair of electrical connectors mechanically and electrically coupled to each other, where the pair of electrical connectors includes at least one floating connector in accordance with embodiments of the present disclosure.

FIG. 7 is a side view of the pair of electrical connectors of FIG. 3 mechanically and electrically coupled to each other in accordance with embodiments of the present disclosure.

FIG. 8A is a perspective view of the pair of electrical connectors of FIG. 3 mechanically and electrically coupled to each other in accordance with embodiments of the present disclosure.

FIG. 8B is a perspective view of the pair of electrical connectors of FIG. 3 mechanically and electrically decoupled from each other in accordance with embodiments of the present disclosure.

FIG. 9 is an exploded view of the pair of electrical connectors of FIG. 3 in accordance with embodiments of the present disclosure.

FIG. 10A-B are perspective views of a resilient member of an electrical connector in accordance with embodiments of the present disclosure.

FIG. 10C is a side view of a resilient member of an electrical connector in accordance with embodiments of the present disclosure.

FIG. 11A-B are side views of a casing for an electrical connector in accordance with embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The components of embodiments of the present disclosure have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Blade and receptacle-style electrical connectors can include a rigidly mounted male (blade) connector on a first device (e.g., a terminal or electronic device side) and a female (receptacle) connector on a second device (e.g., a battery side). A significant concern regarding the durability of blade-style connectors arises with respect to impacts from drops or tumbles, where the inertia-induced relative motion between the connected devices can generate a shear force on the electrical connector blades and its casing, leading to wear and tear on the blade connector and/or the receptacle connector. This concern can be more pronounced when a significant portion of the second device (e.g., a battery) remains unprotected by the first device (e.g., a terminal) or vice versa, such as when the second device (e.g., the battery) is not retained within a (battery) compartment of a housing of the first device (e.g., the terminal).

As an example, a housing of the second device can be mechanically connected to a housing of the first device, such that the housings of the first and second devices are exposed, and an electrical connection can be formed between the first and second devices via, e.g., mated blade and receptacle-style electrical connectors. While the mechanical coupling of housings of the first and second devices can provide some protection to the integrity of the electrical connectors, the impact from a drop can still result in some movement between the housings of the first and second devices placing a stress on the electrical connectors, which may result in the blades being bent or otherwise damaged.

Embodiments of the present disclosure provide for a floating blade electrical connector configured to mate with a receptacle electrical connector, ensuring enhanced durability and mechanical resistance to mitigate damage of the blade electrical connector and/or the receptacle electrical connector due to drops and tumbles when the electrical connectors are connected. As an example, when housings of first and second device are mechanically coupled, providing some protection to the integrity of the electrical connectors, the floating blade connector can absorb at least some of the impact caused by movement between the housings of first and second devices reducing a stress on the electrical connectors, which may prevent the blades from being bent or otherwise damaged.

Embodiments of the present disclosure provide for robust design that can significantly extend the lifespan of the blade and/or receptacle electrical connector, the first device (e.g., a terminal), and/or the second device (e.g., a battery), reducing the need for frequent replacements and minimizing the downtime resulting from a damaged or degraded connection between the first and second devices.

In accordance with embodiments of the present disclosure, a system is disclosed. The system includes a first electronic device, an electronic component, and a first electrical connector. The first electronic device has a first housing with a first device interface area. The electronic component is disposed in the first housing. The first electrical connector is secured to the first housing in the first device interface area and operatively coupled to the electronic component. The first electrical connector includes a first casing and a resilient member. The first casing supports a first plurality of conductive contacts having elongated bodies that extend from the first casing. The resilient member forms a sleeve around the first casing such that the first casing nests within the resilient member. The resilient member is disposed between the first casing and the first housing. The first casing is configured to be movable relative to the housing by reversibly deforming the resilient member.

In accordance with embodiments of the present disclosure, the system can include a second electronic device having a second housing with a second device interface area. The second device interface area includes a second electrical connector operatively coupled to the second housing. The second electrical connector includes a second casing having a plurality of receptacles configured to receive the first plurality of conductive contacts of the first electrical connector. The second electrical connector also includes a second plurality of conductive contacts disposed in the receptacles that are configured to contact the first plurality of conductive contacts when the first electrical connector and the second electrical connector are mated.

In accordance with embodiments of the present disclosure, a portion of the second housing nests with the first housing when the first and second electrical connectors are mated.

In accordance with embodiments of the present disclosure, the resilient member forms a seal around the first casing that prevents fluid from entering the first housing.

In accordance with embodiments of the present disclosure, the resilient member is contoured to conform to a shape of the first casing. The resilient member can include a first base portion defining an opening in the resilient member within which a second base portion of the first casing is received and a first flanged portion of the resilient member disposed adjacent to the first base portion, the first flanged portion configured to support a second flanged portion of the first casing when the second base portion of the first casing is received within the opening of the first base portion of the resilient member.

In accordance with embodiments of the present disclosure, the first electrical connector is asymmetrically disposed in the first device interface area.

In accordance with embodiments of the present disclosure, a center of the first electrical connector is offset from at least one of a center axis of the first device interface or a midline of the first device interface, the center axis extending parallel to a longitudinal axis of the first device interface and the midline extends perpendicular to the longitudinal axis.

In accordance with embodiments of the present disclosure, the resilient member includes a first portion and a second portion, the first portion forms the sleeve around the first casing and the second portion extends from the first portion.

In accordance with embodiments of the present disclosure, the second portion of the resilient member is disposed between the first and second device interface areas when the first and second electrical connectors are mated and the second portion of the resilient member is compressed between the first and second housings.

In accordance with embodiments of the present disclosure, when the first and second electrical connectors are mated, the resilient member is configured to absorb at least a portion of a force on the first casing resulting from an impact after the system is dropped.

In accordance with embodiments of the present disclosure, a method is disclosed. The method includes defining a first device interface area on a first housing of a first device and operatively coupling a first electrical connector to the first housing within the first device interface area. The first electrical connector includes a resilient member and a first casing. The first casing supports a first plurality of conductive contacts having elongated bodies extending from the first casing. The resilient member forms a sleeve around the first casing such that the first casing nests within the resilient member and the resilient member is disposed between the first casing and the first housing. The first casing is configured to be movable relative to the housing by reversibly deforming the resilient member. The method also includes defining a second device interface area on a second housing of a second device and operatively coupling a second electrical connector to the second housing within the second device interface area. The second electrical connector includes a second casing having a plurality of receptacles and a second plurality of conductive contacts disposed in the receptacles. The receptacles are configured to receive the first plurality of conductive contacts of the first electrical connector. The second plurality of conductive contacts are configured to contact the first plurality of conductive contacts when the first electrical connector and the second electrical connector are mated.

In accordance with embodiments of the present disclosure, the method also includes forming a seal around the first casing with the resilient member to prevent fluid from entering the first housing.

In accordance with embodiments of the present disclosure, the method includes positioning the first electrical connector asymmetrically within the first device interface area.

In accordance with embodiments of the present disclosure, disposing the second portion of the resilient member between the first and second device interface areas when the first and second electrical connectors are mated and compressing the second portion of the resilient member between the first and second housings in response to the first and second electrical connectors being mated.

In accordance with embodiments of the present disclosure, the method includes when the first and second electrical connectors are mated, absorbing, via the resilient member, at least a portion of a force on the first casing resulting from an impact after the first device is dropped.

In accordance with embodiments of the present disclosure, an electrical connector is disclosed. The electrical connector includes a casing, a plurality of conductive contacts, and a resilient member. The casing includes a pair of alignment posts spaced away from each other and a recessed portion disposed between the pair of alignment posts. A plurality of conductive contacts having elongated bodies are supported by the casing and extend from the casing into the recessed portion. The plurality of conductive contacts being formed of an electrically conductive material. The resilient member forms a sleeve around the casing such that the casing is nested within the resilient member and the alignment posts and the plurality of conductive contacts project out of the sleeve.

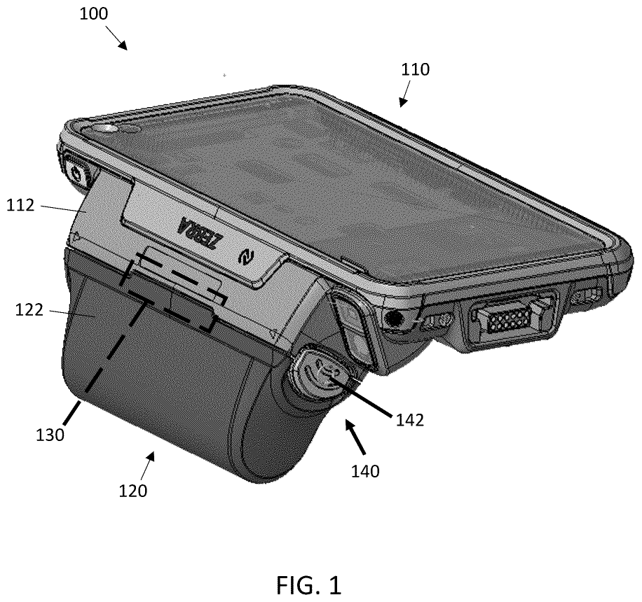

With reference to FIGS. 1-3, an example system 100 that includes a first device 110 and a second device 120 that is configured to be electrically and mechanically coupled to the first device 110 is provided in accordance with embodiments of the present disclosure. In the present example, the first device 110 can be a terminal or electronic/computing device and the second device 120 can be a battery. While the present example illustrates a battery electrically and mechanically coupled to a terminal, in example embodiments of the present disclosure, the first and second devices are not limited to a terminal and battery but can be any devices coupled by an electrical connector, where the electrical connector can facilitate the transfer of power and/or data between the devices.

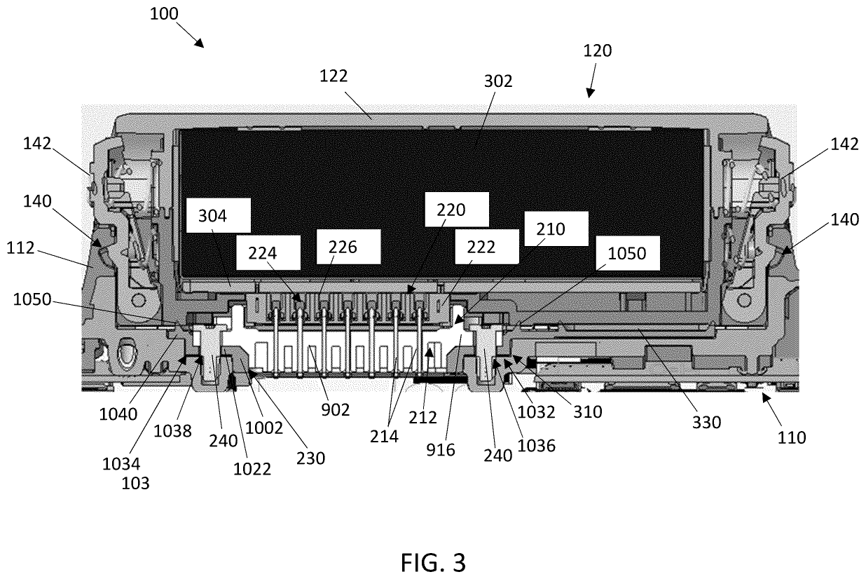

In an example embodiment, the first device 110 can have a housing 112 supporting and/or enclosing electronic components 250 (e.g., a processing device, memory, a display device, input/output (I/O) devices, a communications interface, electrical circuits, etc.). As an example, the first device 110 can be a mobile, portable, and/or wearable terminal or computing device that may be carried and/or held by a user, which may increase the likelihood that the system 100 may be dropped or tumble. The second device 120 can be mechanically and electrically connected to the first device 110 via the pair of electrical connectors 130. In an example embodiment, the connection via the pair of connectors 130 can enable the second device 120 to power the electronic components of the first device 110 and/or exchange data with the first device 110. In an example embodiment, the second device 120 can have a housing 122 supporting one or more electronic components 260 (e.g., battery cells 302 shown in FIG. 3, and in some examples, electric circuitry 304 shown in FIG. 3, such as a charging circuit, a battery management circuit, and/or other circuitry). A first electrical connector 210 of pair of the connectors 130 can be supported by the housing 112 of the first device 110 and a second electrical connector 220 of the pair of connectors 130 can be supported by the housing 122 of the second device 120. While the first electrical connector 210 has been illustrated as being supported by the housing 112 and the second electrical connector 220 has been illustrated as being supported by the housing 122, in example embodiments of the present disclosure, the second electrical connector 220 can be supported by the housing 112 and the first electrical connector 210 can be supported by the housing 122. The housings 112 and 122 can also be mechanically coupled via one or more latches 140, which can selectively lock the housing 122 to the housing 112. As an example, the one or more latches 140 can include actuators 142 that can be actuated to release the latches 140 to facilitate decoupling of the housing 122 from the housing 112.

In the illustrated embodiment, the housing 122 of the second device 120 can be attached/appended to a side of the housing 112 of the first device 110 such that the housing 122 is generally exposed to the environment. With such configurations, the connection between the first device 110 and the second device 120 via the pair of electrical connectors 130 can be susceptible to stresses, and particularly sheer stresses, due to possibility of relative movement of the housings 112 and 122 and the connectors 210 and 220 to each other. In one example, as shown in FIG. 3, at least a portion of the one of the housings 112 or 122 can nest within the other of the housing 112 or 122, which may aid in mitigating movement of housings 112 and 122 relative to each other, e.g., as the result of an impact after being dropped. While an embodiment of the system illustrated in FIGS. 1-3 provides for attaching/appending the housing 122 of the second device 120 to the housing 112 of the first device 110, in example embodiments the housing 112 of the first device 110 can include a compartment (e.g., a battery compartment) to enclose or further support the second device 120 (e.g., a battery) within the first device 110.

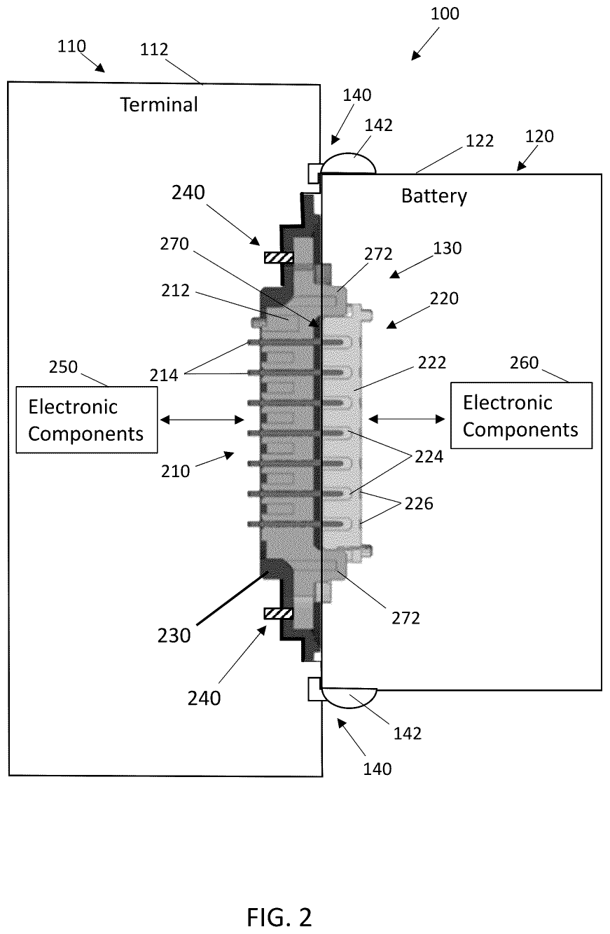

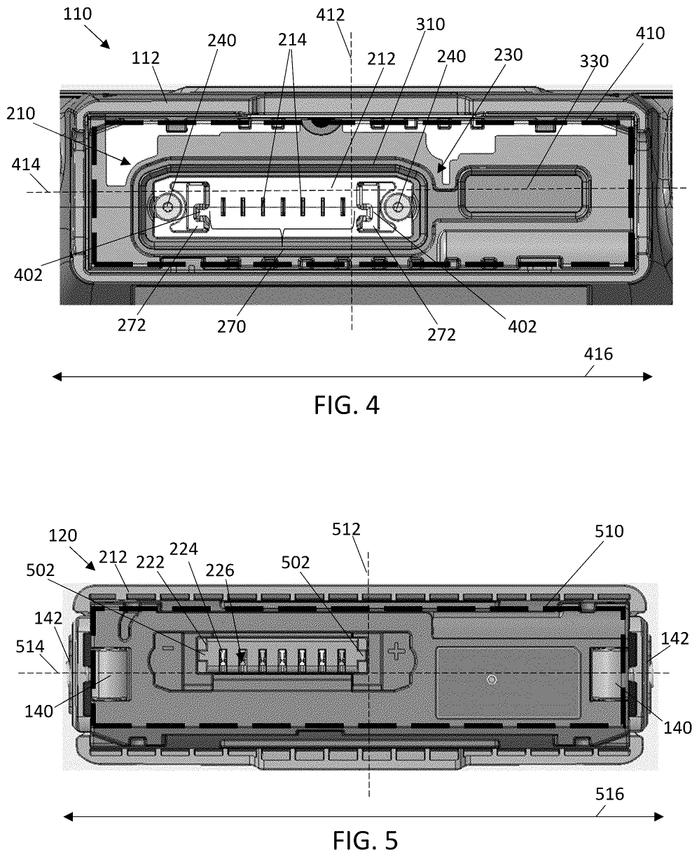

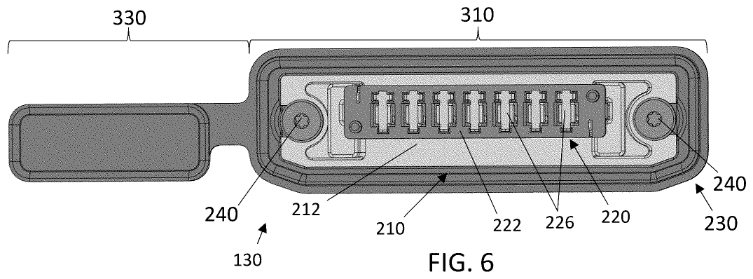

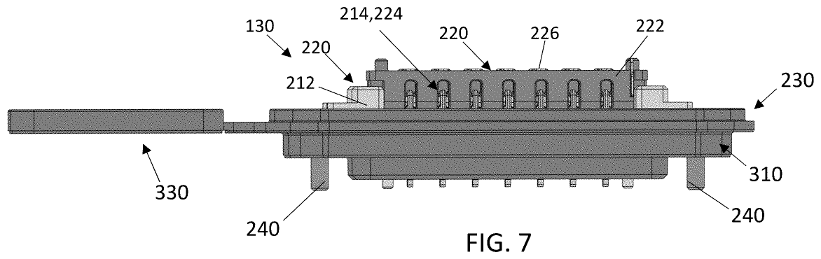

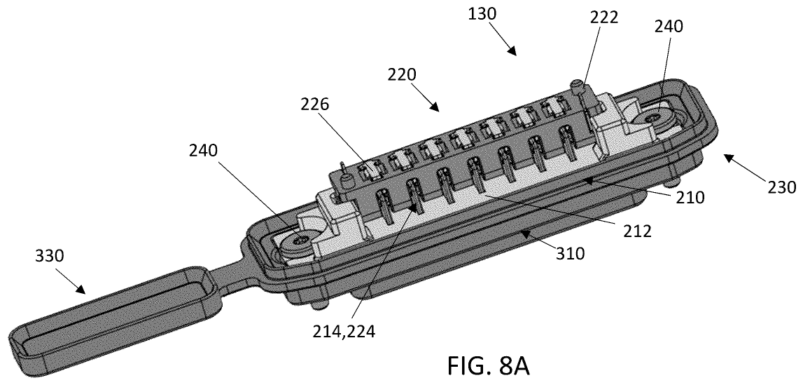

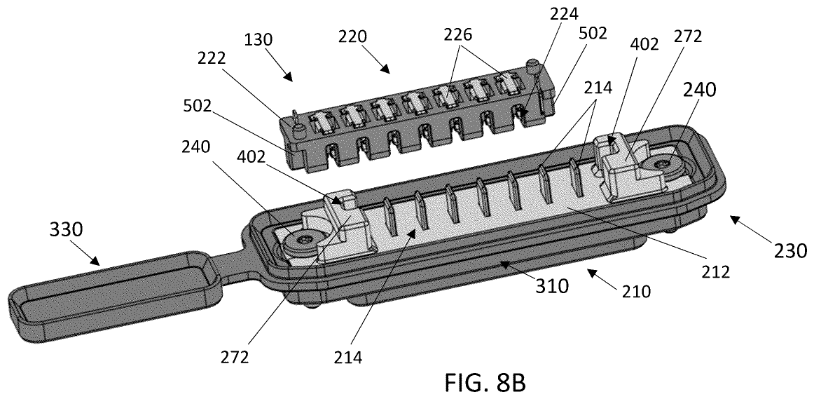

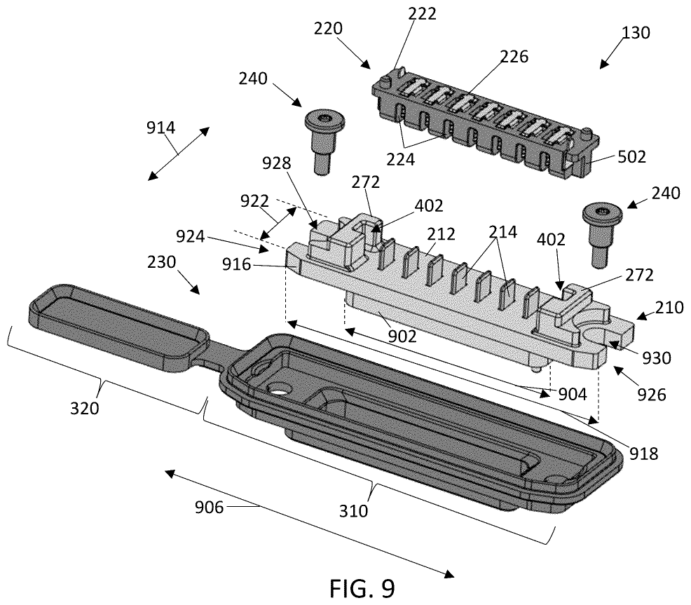

With reference to FIGS. 2-9, the first connector 210 can include a housing/casing 212 supporting elongated conductive electrical contacts 214 and the second connector 220 can include a housing/casing 222 including receptacles 224 configured to receive the elongated contacts 214. The elongated contacts 214 and the receptacles 224 can each be positioned side-by-side in an array with a specified spacing in their respective casing 212 and 222 so that each one of the elongated contacts 214 aligns with a corresponding one of the receptacles when the connectors 210 and 220 are mated. The casings 212 and 222 can be formed on non-conductive materials, such as plastic, and the elongated contacts 214 can be formed of a conductive material, such as metal. A first end of the elongated contact 214 can be electrically connected to one or more electronic components 250 within the housing 112 of the first device 110 and a second end of the elongated contact 214 (opposite the first end) are configured to extend from the casing 212 to matingly engage with the receptacles 224 of the second electric connector. In one example, the elongated contacts can be blades having generally planar rectilinear bodies, such as metal plates, can be pins having generally cylindrical bodies, or can have other elongated shapes and configurations. The receptacles 224 of the second electrical connector 220 can include conductive (metal) contacts 226 positioned in the receptacles 224 such that when the first and second electrical connectors 210 and 220 are mated the elongated contacts 214 extend into receptacles 224 and contact the conductive contacts 226 to facilitate an electrical connection between the first and second electrical connectors 210 and 220. The conductive contacts 226 of the second electrical connector 220 can be electrically connected to one or more electrical components 260 within the housing 122 of the second device 120. The casing 212 can include a recessed portion 270 between alignment posts 272 (including guide slots 402, e.g., shown in FIGS. 4 and 8B) where the elongated contacts 214 extend parallel relative to each other from the casing 212 into the recessed portion 270 such that a corresponding portion of the casing 222 can be received in the recessed portion when the first and second electrical connectors 210 and 220 are mated. The alignment posts 272 can project from the casing 212 parallel to the elongated contacts 214. The casing 222 of the connector 220 can include guide members 502 (e.g., shown in FIGS. 5 and 8B) that form rails configured to be received by the guide slots 402 (e.g., shown in FIGS. 4 and 8B) to align the first connector 210 and the second 220 and align the elongated contacts 214 with the receptacles 224 to facilitate mechanical and electrical mating of the connectors 210 and 220.

The first electrical connector 210 can include or be configured to nest within a resilient member 230 that forms a contoured sleeve around the casing 212 such that the resilient member 230 is disposed around the casing and between the housing 112 and the casing 212. The resilient member 230 can be formed from a resilient material such as rubber (e.g., silicone rubber) or other resilient materials. As a non-limiting example, the resilient member 230 can have a thickness of between 0.3 mm and 3 mm or can have a thickness of approximately 1 mm. As an example, the resilient member 230 can have a surface that corresponds to and conforms to a shape of at least a portion of the casing 212. The casing 212 and resilient member 230 can be operatively coupled to the housing 112 via one or more fasteners, such as one or more shoulder screws 240. The resilient member 230 can be deformable to allow the casing 212 to “float” or move relative to the housing 112, for example, in response to an impact of the connected first and second devices 110 and 120 being dropped, ensuring enhanced durability and mechanical resistance to mitigate damage of the elongated contacts 214 and/or casing 212 of electrical connector 210 and/or the conductive contacts 226, the recesses 224, and/or the casing 222 of the electrical connector 220 due to drops and tumbles when the electrical connectors are mechanically and electrically connected. The use of the electrical connector 210 can significantly extend the lifespan of the elongated contacts 214, casing 212, conductive contacts 226, recesses 224, casing 222, and the first and second devices (e.g., a terminal and a battery). This can reduce the need for frequent replacements and minimize downtime caused by a damaged or degraded connection between the first and second devices 110 and 120. Being disposed between the casing 212 and the housing 112 and secured with the fasteners 240, the resilient member 230 can create a seal that prevents fluid (e.g., water) from entering the housing 112. When the electrical connectors 210 and 220 are mated and the housings 112 and 122 are connected via the latch 140, the resilient member 230 can be compressed between the housings 112 and 122 and can create a seal that can protect the electrical connectors 210 and 220 from fluids (e.g., water).

With reference to FIGS. 3-5, the connectors 210 and/or 220 can be asymmetrically disposed relative to device interface areas 410 and 510, respectively, As an example, the connectors 210 and/or 220 can be offset from midlines 412 and 512 of respective device interface areas 410 and 510 of the housings 112 and 222 and/or can be offset relative to center axes 414 and 514 of the respective device interface areas 410 and 510 of the housings 112 and 222, where the center axes 414 and 514 extend parallel along longitudinal axes 416 and 516 of the device interface areas 410 and 510, respectively and the midlines 412 and 512 extend perpendicular to the longitudinal axes 416 and 516, respectively. In one example, having the connectors 210 and/or 220 offset relative to the midlines 412 and 512 and center axes 414 and 514 of the device interface areas 410 and 510, respectively, can create an imbalance between the housings 112 and 122 when the connectors 210 and 220 are mechanically and electrically mated. This imbalance can introduce instability into the system 100. To mitigate or eliminate this imbalance, the resilient member 230 can include first portion 310 extending about the casing 212 and a second portion 330 that extends from and is adjacent to the first portion 310 such that the first and second portions are positioned side-by-side. The second portion 330 can be supported and/or affixed to by a surface the housing 112 within the device interface area 410 such that when the connectors 210 and 220 are connected and the device interface areas 410 and 510 oppose each other, the second portion 330 of the resilient member 230 can be disposed between the second housing 122 of the second device 120 and the first housing 112 of the first device 110, where the second portion 330 of the resilient member 230 can be compressed by the first and second housings 112 and 122, which can aid in stabilize the connection between the device 110 and 120. While the resilient member 230 has been illustrated as including the first portion 310 and the second portion 330, embodiments of the resilient member 230 can be devoid of the second portion 330.

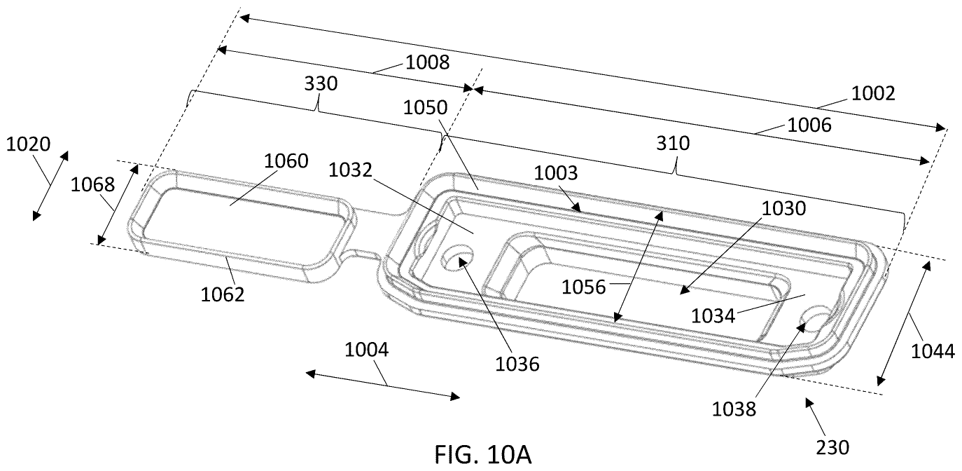

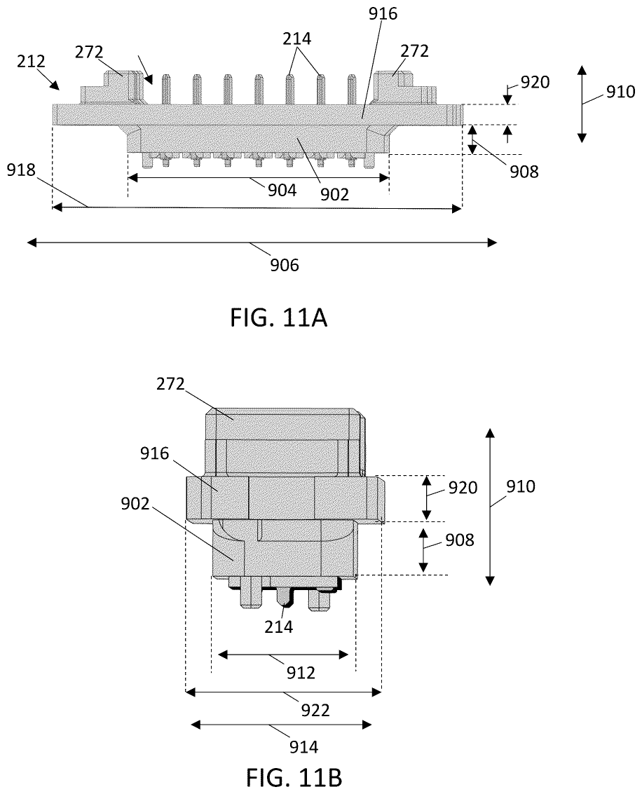

With reference to FIGS. 9 and 11A-B, the casing 212 of the electrical connector 210 can include a first or base portion 902 having a length 904 (measured along a longitudinal axis 906), a height 908 (measure along a vertical axis 910), and a width 912 (measured along a transverse axis 914) and a second or flanged portion 916 having a length 918 (measured along the longitudinal axis 906), a height 920 (measure along the vertical axis 910), and a width 922 (measured along the transverse axis 914). The axes 906, 910, and 914 are each perpendicular to each other. The base portion 902 and the flanged portion 916 can each have a generally rectangular shape. The flanged portion 916 can be adjacently disposed relative to the base portion 902 and the length 918 and width 922 of the flanged portion 916 can be greater that the length and width of the base portion 902 such that the flanged portion 916 extends beyond or overhangs the base portion 902 on each of the sides of the casing 212. Opposing sides 924 and 926 spaced away from each other along the longitudinal axis 904 can include open ended notches 928 and 930, respectively. The notches 928 and 930 are configured to receive the fasteners 240 to secure the casing 212 (with the resilient member 230) to the housing 112 of the first device 110. The open-ended notches 928 and 930 can allow the casing 212 to move asymmetrically relative to the housing 112 when the casing 212 is secured to the housing 112 via the fasteners 240. As an example, the side 924 can move in a first direction along the vertical axis 910 and the side 926 can move in a second direction opposite the first direction along the vertical axis 910 which still being secured to the housing 112. As another example, the casing 212 can move in a first direction along the axis 914 and/or in a second direction along the axis 906 perpendicular to the first direction.

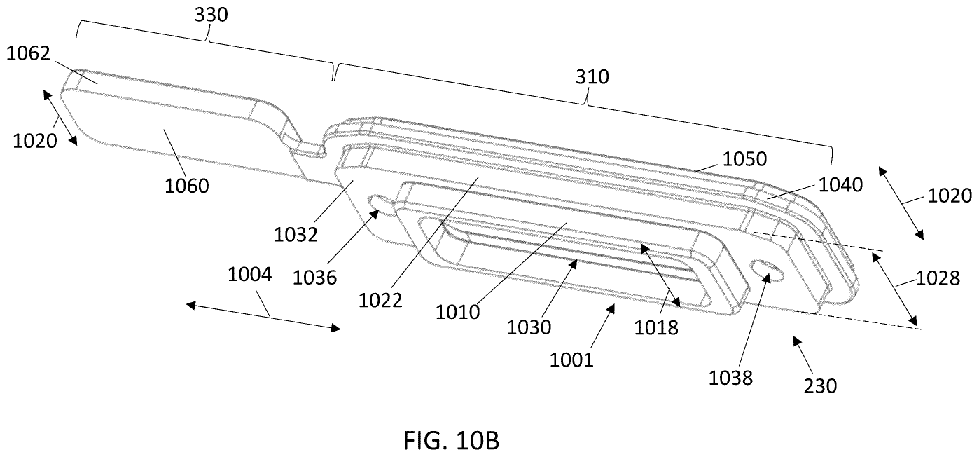

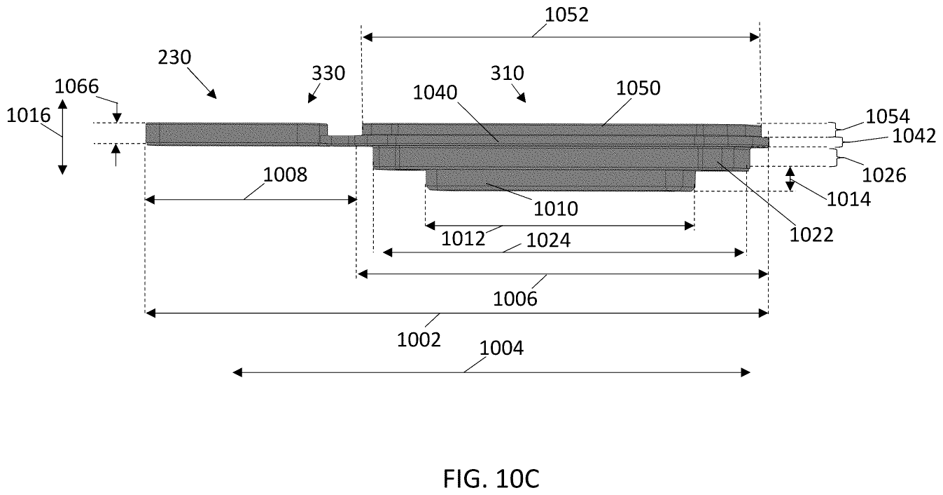

With reference to FIGS. 10A-C, the resilient member 230 can have a length 1002 (measured along a longitudinal axis 1004) which is the sum of a length 1006 of the first portion 310 and the length 1008 of the second portion 330. For embodiments in which the resilient member 230 is devoid of the second portion 330, the length of the resilient member 230 can be the length 1006 of the first portion 310. The first portion 310 of the resilient member 230 can have an open bottom 1001 and an open top 1003 where the open top 1003 is larger than the open bottom 1001 and can have a stepped perimeter that forms a sleeve corresponding to the perimeter of the casing 212. The first portion 310 can include a base portion 1010 having a length 1012 (measured along a longitudinal axis 1004), a height 1014 (measure along a vertical axis 1016), and a width 1018 (measured along a transverse axis 1020) and a flanged portion 1022 having a length 1024 (measured along the longitudinal axis 1004), a height 1026 (measure along the vertical axis 1016), and a width 1028 (measured along the transverse axis 1020). The axes 1004, 1016, and 1020 are each perpendicular to each other. The base portion 1010 and the flanged portion 1022 can each have a generally rectangular shape. The flanged portion 1022 can be adjacently disposed relative to the base portion 1010 and the length 1024 and width 1028 of the flanged portion 1022 can be greater that the length 1012 and width 1018 of the base portion 1010 such that the flanged portion 1022 extends beyond or overhangs the base portion 1010 on each of the sides of the first portion 310. The base portion 1010 and the flanged portion 1022 can have an opening 1030 corresponding to the open bottom and which is configured and dimensioned to receive the base portion 902 of the casing 212 while preventing the flanged portion 916 from passing through the opening 1030. The base portion 1010 can surround the base portion 902 of the casing 212. Sides 1032 and 1034 of the flanged portion 1022 are spaced away from each other along the longitudinal axis 1004 and are on opposites sides of the opening 1030. The sides 1032 and 1034 can include through-holes 1036 and 1038, respectively, that are configured to receive the fasteners 240. The sides 1032 and 1034 can have a planar configuration that are parallel to a plane defined by the axes 1004 and 1020. The flanged portion 916 of the casing 212 can rest upon the sides 1032 and 1034 of the flanged portion 1022 of the first portion 310 of the resilient member 230 when the base portion 902 of the casing 212 is received with the opening 1030 of the first portion and the notches 928 and 930 of the flanged portion 916 can be vertically aligned with the through-holes 1036 and 1038.

The first portion 310 can include a lip 1040 disposed adjacent to the flanged portion 1022. The lip 1040 can be the length 1006 and width 1044 of the first portion 310. The lip 1040 can have a height 1042 (measured along the vertical axis 1016). The length 1006 and the width 1044 of the lip 1040 can be greater that the length 1024 and width 1028 of the flanged portion 1022 such that the lip 1040 extends beyond or overhangs the flanged portion 1022 on each of the sides of the flanged portion 1022.

The first portion 310 can include a seal ring 1050 disposed adjacent to the lip 1040. The seal ring 1050 can have a length 1052 (measured along the longitudinal axis 1004), a height 1054 (measured along the vertical axis 1016), and a width 1056 (measured along the transverse axis 1020). The length 1052 and the width 1056 of the seal ring 1050 can be less than that the length 1042 and width 1046 of the lip 1040 such that the perimeter of the seal ring 1050 smaller that a perimeter of the lip 1040.

The second portion 330 of the resilient member 230 extends from the lip 1040 of the first portion 310 and defines a pad including a planar base 1060 and a raised perimeter or seal ring 1062. The second portion can have the length 1008, a height 1066 (measured along the vertical axis 1016), and a width 1068 (measured along the transverse axis 1020). The planar base 1060 can be secured to the housing 112 in the device interface area 410 (FIG. 4) adjacent and side-by-side relative to the first portion 310.

With reference to FIGS. 3 and 9, 10A-C, and 11A-B, the housing 112 can be contoured where the electrical connector 210 is received by the housing 112 to correspond to the shape of the electrical connector 210 such that the housing 112 can have a stepped profile that is recessed relative to a surface of the housing 112 within the device interface area 410 (FIG. 4). When the electrical connector 210 is secured to the housing 112 of the first device 110, a top of flanged portion 916 of the casing 212 can be generally flush relative to the surface of the housing 112 within the device interface area 410 that surrounds the electrical connector 210 and the alignment posts 272 and elongated electrical contacts 214 can extend beyond or be raised relative to housing 112 surrounding the electrical connector 210. The lip 1040 can be recessed relative to the surface of the housing 112 surrounding the electrical connector 210 on at least one side of the electrical connector such that the lip 1040 lays below the surface of the housing 112 on the at least one side of the electrical connector 210 and a top surface of the lip 1040 is flush with the surrounding surface of the housing 112 (e.g., a left side as shown in FIG. 3). In one example, as shown in FIG. 3, different portions of surface of the housing 112 surrounding the electrical connector 210 can be recessed relative to each other such that one portion of the surface of the housing resides in a first plane and a second portion of the surface resides in a second different plane that is parallel to the first plane. As an example, on the side of the electrical connector 210 that includes the second portion 330 of the resilient member (e.g., the right side as shown in FIG. 3), the surface of the housing can be recessed relative to the surface of the housing on the other side of the connector 210 (e.g., the left side of the electrical connector 210), and the lip 1040 of the first portion 310 and the planar base 1060 of the second portion 330 can lay over and abut the surface of the housing 112. The seal ring 1050 extends from the lip 1040 protrude outwardly and beyond the surface of the housing 112 surrounding the electrical connector 210. The height 1066 of the second portion 330 of the resilient member 230 and the aggregate heights 1042 and 1054 of the lip 1040 and the seal ring 1050, respectively, can be equal to each other such that a top (as oriented in FIG. 3) of the second portion 330 and the seal ring 1050 reside in the same plane parallel to a plane defined by the longitudinal axis 1004 and the transverse axis 1020.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A system comprising:
a first electronic device having a first housing with a first device interface area,
an electronic component disposed in the first housing;
a first electrical connector secured to the first housing in the first device interface area and electrically coupled to the electronic component, the first electrical connector comprises:
a first casing supporting a first plurality of conductive contacts having elongated bodies that extend from the first casing; and
a resilient member forming a sleeve around the first casing such that the first casing nests within the resilient member, the resilient member is disposed between the first casing and the first housing, the first casing configured to be movable relative to the housing by reversibly deforming the resilient member.

2. The system of claim 1, further comprising:
a second electronic device having a second housing with a second device interface area, the second device interface area including a second electrical connector operatively coupled to the second housing, the second electrical connector comprises:
a second casing having a plurality of receptacles configured to receive the first plurality of conductive contacts of the first electrical connector; and
a second plurality of conductive contacts disposed in the receptacles that are configured to contact the first plurality of conductive contacts when the first electrical connector and the second electrical connector are mated.

3. The system of claim 2, wherein a portion of the second housing nests with the first housing when the first and second electrical connectors are mated.

4. The system of claim 1, wherein the resilient member forms a seal around the first casing that prevents fluid from entering the first housing.

5. The system of claim 1, wherein the resilient member is contoured to conform to a shape of the first casing, the resilient member further comprising:
a first base portion defining an opening in the resilient member within which a second base portion of the first casing is received; and
a first flanged portion of the resilient member disposed adjacent to the first base portion, the first flanged portion configured to support a second flanged portion of the first casing when the second base portion of the first casing is received within the opening of the first base portion of the resilient member.

6. The system of claim 1, wherein the first electrical connector is asymmetrically disposed in the first device interface area.

7. The system of claim 6, wherein a center of the first electrical connector is offset from at least one of a center axis of the first device interface or a midline of the first device interface, the center axis extending parallel to a longitudinal axis of the first device interface and the midline extends perpendicular to the longitudinal axis.

8. The system of claim 6, wherein the resilient member includes a first portion and a second portion, the first portion forms the sleeve around the first casing and the second portion extends from the first portion.

9. The system of claim 8, further comprising:
a second electronic device having a second housing with a second device interface area, the second device interface area including a second electrical connector operatively coupled to the second housing, the second electrical connector comprises:
a second casing having a plurality of receptacles configured to receive the first plurality of conductive contacts of the first electrical connector; and
a second plurality of conductive contacts disposed in the receptacles that are configured to contact the first plurality of conductive contacts when the first electrical connector and the second electrical connector are mated,
wherein the second portion of the resilient member is disposed between the first and second device interface areas when the first and second electrical connectors are mated and the second portion of the resilient member is compressed between the first and second housings.

10. The system of claim 1, wherein when the first and second electrical connectors are mated, the resilient member is configured to absorb at least a portion of a force on the first casing resulting from an impact after the system is dropped.

11. A method comprising:
defining a first device interface area on a first housing of a first device;
operatively coupling a first electrical connector to the first housing within the first device interface area, the first electrical connector includes a resilient member and a first casing, the first casing supports a first plurality of conductive contacts having elongated bodies extending from the first casing, the resilient member forms a sleeve around the first casing such that the first casing nests within the resilient member and the resilient member is disposed between the first casing and the first housing; the first casing is configured to be movable relative to the housing by reversibly deforming the resilient member;
defining a second device interface area on a second housing of a second device; and
operatively coupling a second electrical connector to the second housing within the second device interface area, the second electrical connector includes a second casing having a plurality of receptacles and a second plurality of conductive contacts disposed in the receptacles, the receptacles configured to receive the first plurality of conductive contacts of the first electrical connector, the second plurality of conductive contacts are configured to contact the first plurality of conductive contacts when the first electrical connector and the second electrical connector are mated.

12. The method of claim 11, further comprising:
forming a seal around the first casing with the resilient member to prevent fluid from entering the first housing.

13. The method of claim 11, wherein the resilient member is contoured to conform to a shape of the first casing

14. The method of claim 11, further comprising:
positioning the first electrical connector asymmetrically within the first device interface area.

15. The method of claim 14, wherein a center of the first electrical connector is offset from at least one of a center axis of the first device interface or a midline of the first device interface, the center axis extending parallel to a longitudinal axis of the first device interface and the midline extends perpendicular to the longitudinal axis.

16. The method of claim 14, wherein the resilient member includes a first portion and a second portion, the first portion forms the sleeve around the first casing and the second portion extends from the first portion.

17. The method of claim 16, further comprising:
disposing the second portion of the resilient member between the first and second device interface areas when the first and second electrical connectors are mated; and
compressing the second portion of the resilient member between the first and second housings in response to the first and second electrical connectors being mated.

18. The method of claim 11, further comprising:
wherein when the first and second electrical connectors are mated, the resilient member is configured to absorb at least a portion of a force on the first casing resulting from an impact after the system is dropped.

19. An electrical connector comprising:
a casing, the casing including a pair of alignment posts spaced away from each other and a recessed portion disposed between the pair of alignment posts;
a plurality of conductive contacts having elongated bodies supported by the casing and extending from the casing into the recessed portion, the plurality of conductive contacts being formed of an electrically conductive material;
a resilient member forming a sleeve around the casing such that the casing is nested within the resilient member and the alignment posts and the plurality of conductive contacts project out of the sleeve.

20. The electrical connector of claim 19, wherein the resilient member is contoured to conform to a shape of the first casing and includes a first portion and a second portion, the first portion forms the sleeve around the casing and the second portion extends from the first portion.
